(19) United States
(12) Patent Application Publication
(10) Pub. No.: US 2003/0146665 A1
(43) Pub. Date: Aug. 7, 2003

(54) Electrically activated lamp or appliance switch and controller

(76) Inventor: Gary William Germano, Sonoma, CA (US)

Correspondence Address: Gary W. Germano, 18850 Melvin Avenue, Sonoma, CA, 95476, US

(21) Appl. No.: 10/067,647

(22) Filed: Feb. 4, 2002

(51) Int. Cl. H02B 1/24

(52) U.S. Cl. 307/114

(57) ABSTRACT

An portable electric switching device plugged in series with a wall switch controlled electrical outlet and the power cord plug of a lamp or appliance formerly plugged into that same outlet, allowing the lamp or appliance to always be able to be “turned on” by the wall switch controlling that same electrical wall outlet, even when the lamp or appliance is itself turned “off” at it's remote location. This device requires no additional power to operate other than that supplied by the above switched outlet.

### BACKGROUND OF THE INVENTION

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

This invention relates to switching on and off an electrical power circuit: more particularly being able to switch “on” a lamp or other electrical appliance from a “wall switch” controlling the electrical outlet that the device is plugged into, even when the switch at the lamp or appliance is turned “off”.

In the early 1950's and prior, most rooms in homes, especially bedrooms, were fitted with ceiling light fixtures controlled by an on and off switch located at the room's entry door. This consistently provided an immediate source of light when the switch was activated upon entering the room. Thereafter from around the late 1950's to present, many rooms in homes, especially bedrooms, were and still are being equipped with no ceiling light, but instead a switched electrical wall outlet controlled by an on/off switch located at the room's entry door. The latter situation is also frequently found in hotel and motel rooms. This situation requires a lamp or some type of light to be plugged into the switched outlet to provide light when entering the room.

An inconvenience and safety concern arises when, in a bedroom for example, a person's bedside lamp which is plugged into such a wall switch controlled electrical outlet is turned “on” during the evening, and the person turns the light “off” at the lamp switch prior to going to sleep. The lamp switch itself is not turned back on in the morning (due to, for example, the daylight). When re-entering the room at a later time, the lamp cannot be turned on by the wall switch at the door because although the power at the door switch is still turned on, the lamp itself is turned off (electrically disconnected) at its own switch. A person must then walk through the room to the location of the lamp to turn the lamp on. As the room becomes dark in the evening, this can pose a tripping or safety hazard. This hazard is even greater when entering a motel or hotel room in the dark, as a traveler would be unfamiliar with the layout of the furnishings in the room.

### BRIEF SUMMARY OF THE INVENTION

This invention is a portable “plug in” switching device that can easily be added to a lamp or appliance by anyone who is able to plug a power cord into a wall outlet. It requires no additional continuous (un-switched) power to operate; it plugs only into the exact same single wall switched outlet that the portable lamp or appliance was currently connected to. It is installed by unplugging the lamp or appliance from the switched electrical wall socket where it is currently plugged, plugging this device in, and then plugging the lamp or appliance into this device. This device is self contained (although it could be “built into” a lamp or appliance), and does not alter a building's permanent wiring in any way. The device's small on and off switch console is put at the lamp or appliance (or, for example, on a night stand), and becomes the new on and off switch for the appliance. The appliance's original built in switch will be permanently left “on”. Now, if you enter the room and the (lamp, for example) was left turned “on” at the wall switch but turned “off” at the lamp itself, all you need to do is to turn the wall switch “off”, then back “on” again, and the lamp will light. You will not have to enter an unlit/dark room when using this invention. This is desirable from safety, practical, and convenience standpoints. Additionally, this device can be used as a simple remote on/off switch for a lamp or appliance which plugs into a 110 volt power outlet.

### BRIEF DESCRIPTION OF THE VIEWS OF THE DRAWING

FIG. 1, Electrical Schematic Drawing:

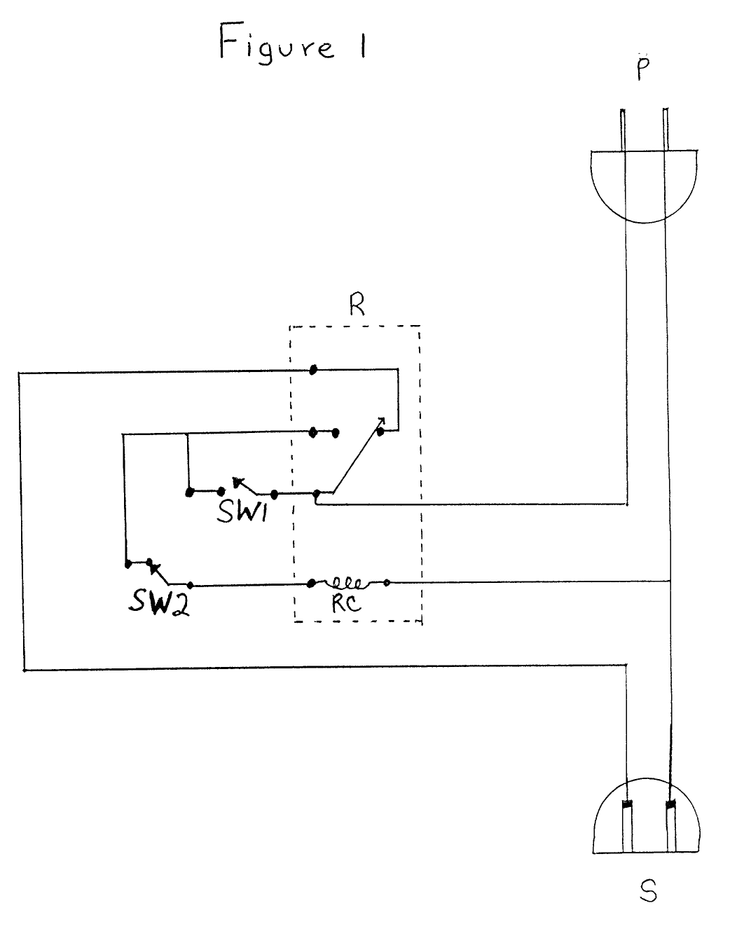

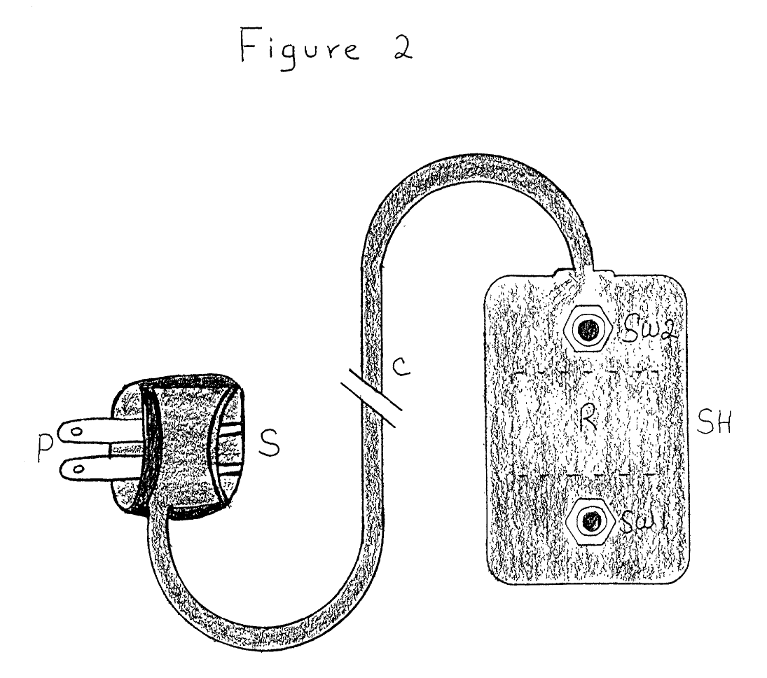

P: The 110 volt plug which plugs into the switched electrical wall outlet formerly occupied by the lamp or appliance.

S: The 110 volt socket which becomes the new power source for the lamp or appliance that was formerly plugged into the above switched wall outlet.

SW1: The momentary contact switch pushed to activate relay R to turn the lamp or appliance “off” at the location of the switch box housing.

SW2: The momentary contact switch pushed to deactivate relay R to turn the lamp or appliance “on” at the location of the switch box housing.

R: The 110 Volt Relay which switches the lamp or appliance power on and off. It is activated by SW1 above, and deactivated by SW2 above or the power switch controlling the switched wall outlet in the room. Deactivating the relay closes the electrical circuit to allow power to flow to the lamp.

FIG. 2, External Physical Characteristic Drawing.

P: The 110 volt plug which plugs into the switched electrical wall outlet formerly occupied by the lamp or appliance.

S: The 110 volt socket which becomes the new power source for the lamp or appliance that was formerly plugged into the above switched wall outlet.

SW1: The momentary contact switch pushed to activate relay R to turn the lamp or appliance “off” at the location of the switch box housing.

SW2: The momentary contact switch pushed to deactivate relay R to turn the lamp or appliance “on” at the location of the switch box housing.

SH: Switch and relay (switch “box”) housing.

C: Cord assembly with grommet/strain relief.

R: The 110 Volt Relay which switches the lamp or appliance power on and off.

### DETAILED DESCRIPTION OF THE INVENTION

This invention uses a single pole, double throw, 110 volt electric relay (R) with a 110 volt activating coil (RC), one single pole single throw (black colored button) normally open (turn “off”) momentary contact switch (SW1), one single pole single throw (red colored button) normally closed (turn “on”)momentary contact switch (SW2), one small plastic switch “box” housing (SH) with connecting wires to contain the above items, one cord (C) with grommet/strain relief to connect the small switch box housing to a “piggy back wired in series” AC plug (P) and socket (S). The negative lead from the AC plug (P) is directly connected to the negative terminal on the AC socket (S) which the lamp or appliance plugs into, and also to one side terminal of the 110 volt coil (RC) on the AC relay in the switch box housing (SH) via the connecting cord (C). The positive lead from the AC plug (P) connects via the connecting cord (C) to the center contact point “switching leg” of the 110 volt relay (R) in the switch housing (SH), and also to one side of the single pole single throw (black colored button) normally open (turn “off”) momentary contact switch (SW1) in the switch housing (SH). The remaining terminal on this single pole single throw (black colored button) normally open (turn “off”) momentary switch (SW1) is connected to the normally open (with no power to the coil applied) switching contact point of the single pole, double throw 110 volt relay (R), and also to one side of the single pole single throw (red colored button) normally closed (turn “on”) momentary contact switch (SW2) in the switch housing (SH). The remaining terminal on the single pole single throw (red colored button) normally closed (turn “on”) momentary contact switch (SW2) connects to the remaining side terminal on the 110 volt coil on the AC relay. The remaining normally closed (with no power to the coil applied) contact point terminal of the single pole, double throw 110 volt relay (R) is connected via the connecting cord (C) to the positive terminal on the AC socket (S) which the lamp or appliance plugs into. Note that if a solid state device had the same switching capabilities and electrical specifications as the single pole, double throw 110 Volt electrical relay (R), a substitution could likely be made here. It is intended that the claims cover any modifications which would be within the spirit and scope of the above outlined invention.

### USING THE INVENTION

We will use a lamp as the “load” or appliance being switched “on” and “off”in this example. The AC plug on the lamp is unplugged from the switched AC wall outlet, and the AC plug on this invention is put in its place. The AC plug on the lamp is then inserted into the AC socket on this invention. The built in switch on the lamp is switched to the “on” position and must remain “on” at all times while this invention is being used; as the push button switches mounted in the small plastic “switch box” housing on this invention are the new “on” and “off” switches for the lamp.

When power is switched on at the room wall switch, it flows directly through the normally closed (at rest) points on the 110 volt AC relay., and the lamp's bulb lights. When the momentary contact “black” switch “off” button is pressed, the 110 volt relay coil is activated and pulls the center positive relay contact to what was the normally “open” position, which activates and “locks” the relay's 110 volt coil in the “on” mode and simultaneously disconnects the 110 volt power to the lamp's bulb. At any time, turning off the power at the room's AC outlet wall switch will “unlatch” the relay and reconnect the positive power lead from the AC outlet directly to the lamp's bulb; and the moment the room's AC outlet wall switch is turned back on, the lamp's bulb will light. When the power is on at the room's AC outlet and the lamp's bulb is in the “off” mode at the invention's switch, the lamp's bulb can also be turned back “on” by pressing the momentary contact “red” switch “on” button, which momentarily interrupts the current to the 110 volt AC coil, “unlocking” the relay and reconnecting the 110 volt AC power to the lamp's bulb. I have fabricated and tried this invention and it works excellently.

This invention requires no additional source of power to operate, only that available at the same 110 volt AC switched wall outlet currently used by the existing lamp or appliance. It can be installed safely and easily by anyone at any age who is able to correctly plug a lamp or other appliance into a wall outlet. This very affordable product would be of great service to the general public from a safety and convenience standpoint, especially considering that most homes built from about the mid 1950's on have at least one room (many homes have multiple rooms) equipped with a wall switched AC outlet.

What I claim as my invention is:

1. A 110 volt electrical power plug and power socket assembly providing an “in series” connection between a lamp or appliance's power plug and an electrical wall outlet;
a small “switch box” housing with switches and an electrical cable connecting it to the above, used to manually turn the above assembly's output on and off from a remote location.

2. The means for selecting and directing the current flowing through (1) above as to allow a switched electrical wall outlet to always be able to direct power to the device's electric output socket whenever the wall switch is activated, using no additional sources of electricity to power the circuitry.
